(19) United States
(12) Patent Application Publication
(10) Pub. No.: US 2023/0238662 A1
(43) Pub. Date: Jul. 27, 2023

(54) BATTERY MODULE, BATTERY PACK, AND ELECTRONIC DEVICE

(71) Applicant: Dongguan Poweramp Technology Limited, Dongguan (CN)

(72) Inventors: Shenbo WANG, Dongguan (CN); Kecheng WU, Dongguan (CN)

(73) Assignee: Dongguan Poweramp Technology Limited, Dongguan (CN)

(21) Appl. No.: 18/191,228

(22) Filed: Mar. 28, 2023

Related U.S. Application Data
(63) Continuation of application No. PCT/CN2020/119462, filed on Sep. 30, 2020.

(51) Int. Cl. H01M 50/519; H01M 50/516; H01M 10/42; H01M 50/533

(52) U.S. Cl. CPC H01M 50/519; H01M 50/516; H01M 10/425; H01M 50/533

(57) ABSTRACT

A battery module including a cell assembly and a first circuit board. The cell assembly includes a plurality of battery cells. The plurality of battery cells are connected to the first circuit board. The plurality of battery cells include a first battery cell and a second battery cell, and the first battery cell is inclined with respect to the second battery cell. The first circuit board is disposed between the first battery cell and the second battery cell, the first circuit board is inclined with respect to the first battery cell, and the first circuit board is inclined with respect to the second battery cell. In the battery module, the space inside a battery is sufficiently utilized by disposing the first circuit board in the space between the first battery cell and the second battery cell, thereby effectively improving an energy density.

### CROSS REFERENCE TO THE RELATED APPLICATIONS

This application is a continuation application of International Application No. PCT/CN2020/119462, filed on Sep. 30, 2020, the contents of which are incorporated herein by reference in its entirety.

### TECHNICAL FIELD

This application relates to the field of batteries, and in particular, to a battery module, a battery pack containing the battery module, and an electronic device.

### BACKGROUND

With the miniaturization of wearable electronic devices, electronic devices have imposed higher requirements on batteries, and space available for a battery in an electronic device is smaller. In addition, the shape of a battery compartment in the electronic device is mostly irregular. How to rationally utilize internal space of the battery and increase an energy density of the battery has become a problem to be solved.

### SUMMARY

In view of the fact above, this application provides a battery module and a battery containing the battery module.

An embodiment of this application provides a battery module. The battery module includes a cell assembly and a first circuit board. The cell assembly includes a plurality of battery cells. The plurality of battery cells are connected to the first circuit board. The plurality of battery cells include a first battery cell and a second battery cell, and the first battery cell is inclined with respect to the second battery cell. The first circuit board is disposed between the first battery cell and the second battery cell, the first circuit board is inclined with respect to the first battery cell, and the first circuit board is inclined with respect to the second battery cell.

In some embodiments, each battery cell includes a housing and an electrode assembly accommodated in the housing, and the electrode assembly includes a tab. The housing includes a first main plane and a second main plane disposed opposite to each other along a thickness direction of the battery cell. A seal edge is disposed at one end of the housing along a length direction of the battery cell. The tab extends out of the housing from the seal edge. The first battery cell includes a first tab. The second battery cell includes a second tab. The first tab is opposite to the second tab. The housing further includes a first surface connects the seal edge and the first main plane. A second surface connects the seal edge and the second main plane. A width of the first surface is greater than a width of the second surface along the thickness direction. One end of the first circuit board tilts closer to the first surface of the first battery cell, and an opposite end of the first circuit board tilts closer to the first surface of the second battery cell.

In some embodiments, the first circuit board is disposed between the first tab and the second tab.

In some embodiments, the first tab includes a first soldering portion, and the second tab includes a second soldering portion. The battery module includes a first connecting strip and a second connecting strip. The first connecting strip includes a first fixing portion and a first connecting portion. The first fixing portion is soldered to the first circuit board. The first connecting portion is welded to the first soldering portion. The first soldering portion is disposed between the first fixing portion and the first connecting portion. The second connecting strip includes a second fixing portion and a second connecting portion. The second fixing portion is soldered to the first circuit board. The second connecting portion is welded to the second soldering portion. The second soldering portion is disposed between the second fixing portion and the second connecting portion.

In some embodiments, the first fixing portion and the first connecting portion clamp the first soldering portion. One surface of the first soldering portion is in contact with the first connecting portion, and an opposite surface of the first soldering portion is in contact with the first fixing portion. The second fixing portion and the second connecting portion clamp the second soldering portion. One surface of the second soldering portion is in contact with the second connecting portion, and an opposite surface of the second soldering portion is in contact with the second fixing portion.

In some embodiments, the first soldering portion is disposed between the first surface of the first battery cell and the first circuit board. The second soldering portion is disposed between the second surface of the second battery cell and the first circuit board.

In some embodiments, the first circuit board includes a first side and a second side that are disposed opposite to each other. The first tab is disposed on the first side, and the second tab is disposed on the second side.

In some embodiments, the first circuit board is at an acute angle to the seal edge of the first battery cell, and the acute angle ranges from 30° to 60°.

In some embodiments, the battery module further includes a first insulation piece and a second insulation piece. The first insulation piece wraps at least a part of the seal edge of the first battery cell. The second insulation piece wraps at least a part of the seal edge of the second battery cell.

In some embodiments, a first opening is provided on the first insulation piece. The first tab protrudes from the first opening. A second opening is provided on the second insulation piece. The second tab protrudes from the second opening.

An embodiment of this application further provides a battery pack. The battery pack includes a shell and the battery module according to any one of the foregoing some embodiments. The battery module is accommodated in the shell.

In some embodiments, the battery pack further includes a second circuit board. One end of the second circuit board is connected to the first circuit board of the battery module. Another end of the second circuit board protrudes out of the shell.

In some embodiments, the shell includes an arc bottom plate. A first groove and a second groove are provided on an inner sidewall of the arc bottom plate. The battery pack further includes a first spacer and a second spacer. The first spacer is disposed between the first battery cell of the battery module and the first groove. The second spacer is disposed between the second battery cell of the battery module and the second groove.

In some embodiments, the first spacer covers the first groove, and the second spacer covers the second groove.

In some embodiments, an arc radius of the arc bottom plate is 85 to 110 mm.

In some embodiments, the shell further includes a side plate and an arc cover plate. The side plate is disposed around the arc bottom plate. The arc cover plate is fixedly connected to the side plate. An arc radius of the arc cover plate is 80 to 100 mm.

In some embodiments, the battery pack further includes a fastener. The fastener includes a first bracket, a second bracket, and a connecting portion. The first bracket and the second bracket are disposed on two opposite sides of the connecting portion respectively. The first battery cell of the battery module is held by the first bracket, the second battery cell is held by the second bracket, and the first circuit board is attached to the connecting portion.

In some embodiments, resin is disposed in the shell and is configured to fill a clearance between the shell and the cell assembly of the battery module.

In some embodiments, an injection hole is provided on the shell. The resin fills the shell by low-pressure injection molding.

An embodiment of this application further provides an electronic device. The electronic device includes an electrical component and the battery pack according to any one of some embodiments described above. The electrical component is electrically connected to the battery pack.

In some embodiments, the battery cell is a pouch-type cell, and the tab is made of a material that is a conductive metal or alloy, such as copper, aluminum, nickel, nickel-clad copper, nickel-clad aluminum, or the like.

An embodiment of this application further provides an electronic device. The electronic device includes an electrical component and the battery pack according to any one of some embodiments described above. The electrical component is electrically connected to the battery pack.

The first battery cell of the battery module is inclined with respect to the second battery cell. The first circuit board is disposed between the first battery cell and the second battery cell. The first circuit board is inclined with respect to the first battery cell, and the first circuit board is inclined with respect to the second battery cell. The space inside a battery is sufficiently utilized by disposing the first circuit board in the space between the first battery cell and the second battery cell, thereby effectively improving an energy density. Further, the battery cell is a pouch-type cell. The tab of the pouch-type cell are highly bendable. The tab may be bent at a tilt angle of the battery cell to the circuit board, thereby further improving space efficiency.

### BRIEF DESCRIPTION OF THE DRAWINGS

FIG. 1 is a three-dimensional schematic structural diagram of a battery pack according to an embodiment;

FIG. 2 is a schematic sectional view of a structure of the battery pack shown in FIG. 1;

FIG. 3 is a side view of a battery cell in the battery pack shown in FIG. 1;

FIG. 4 is a schematic sectional view of a structure of the battery cell shown in FIG. 3;

FIG. 5 is a schematic structural diagram of a battery module of the battery pack shown in FIG. 2;

FIG. 6 is a close-up view of a local structure of the battery module shown in FIG. 5;

FIG. 7 is a schematic sectional view of a structure of the battery module shown in FIG. 5;

FIG. 8 is a close-up view of a local structure of the battery module shown in FIG. 7;

FIG. 9 is a schematic structural diagram of a first battery cell in the battery module shown in FIG. 5;

FIG. 10 is a schematic structural diagram of a second battery cell in the battery module shown in FIG. 5;

FIG. 11 is a side view of the battery pack shown in FIG. 1;

FIG. 12 is a schematic structural diagram of a part of a shell of the battery pack shown in FIG. 1;

FIG. 13 is a schematic structural exploded view of a battery pack according to an embodiment; and

FIG. 14 is a brief structural diagram of an electronic device according to an embodiment.

### REFERENCE NUMERALS OF MAIN COMPONENTS

Battery module 100

Battery cell 10

Housing 101

First main plane 1011

Second main plane 1012

Seal edge 1013

First surface 1014

Second surface 1015

Electrode assembly 102

Tab 103

First battery cell 11

First tab 113

First soldering portion 1131

Second battery cell 12

Second tab 123

Second soldering portion 1231

Spacer 14

First circuit board 20

First side 21

Second side 22

First connecting strip 30

First fixing portion 31

First connecting portion 32

Second connecting strip 40

Second fixing portion 41

Second connecting portion 42

Insulation piece 50

First insulation piece 51

First opening 511

Second insulation piece 52

Second opening 521

Second circuit board 60

Shell 70

Arc bottom plate 71

First groove 711

Second groove 712

Side plate 72

Injection hole 721

Arc cover plate 73

First spacer 81

Second spacer 82

Fastener 90

First bracket 91

Second bracket 92

Connecting portion 93

Through-hole 931

Battery pack 200

Electronic device 300

Electrical component 301

### DETAILED DESCRIPTION

The following clearly and thoroughly describes the technical solutions in some embodiments of this application with reference to the drawings hereto. Evidently, the described some embodiments are merely a part of but not all of some embodiments of this application.

It is hereby noted that a component referred to as being “fixed to” another component may be directly fixed onto the other component or may be fixed onto the other component through an intermediate component. A component considered to be “connected to” another component may be directly connected to the other component or may be connected to the other component through an intermediate component. A component considered to be “disposed on” another component may be directly disposed on the other component or may be disposed on the other component through an intermediate component. The terms “vertical”, “horizontal”, “left”, “right” and similar expressions used herein are merely for ease of description.

Unless otherwise defined, all technical and scientific terms used herein bear the same meanings as what is normally understood by a person skilled in the technical field of this application. The terms used in the specification of this application are merely intended to describe specific some embodiments but not to limit this application. The term “and/or” used herein is intended to include any and all combinations of one or more relevant items recited.

An embodiment of this application provides a battery module. The battery module includes a cell assembly and a first circuit board. The cell assembly includes a plurality of battery cells. The plurality of battery cells are connected to the first circuit board. The plurality of battery cells include a first battery cell and a second battery cell, and the first battery cell is inclined with respect to the second battery cell. The first circuit board is disposed between the first battery cell and the second battery cell, the first circuit board is inclined with respect to the first battery cell, and the first circuit board is inclined with respect to the second battery cell.

In the battery module, the space inside a battery is sufficiently utilized by disposing the first circuit board in the space between the first battery cell and the second battery cell, thereby effectively improving an energy density.

The following describes some embodiments of this application in detail. To the extent that no conflict occurs, the following some embodiments and the features in some embodiments may be combined with each other.

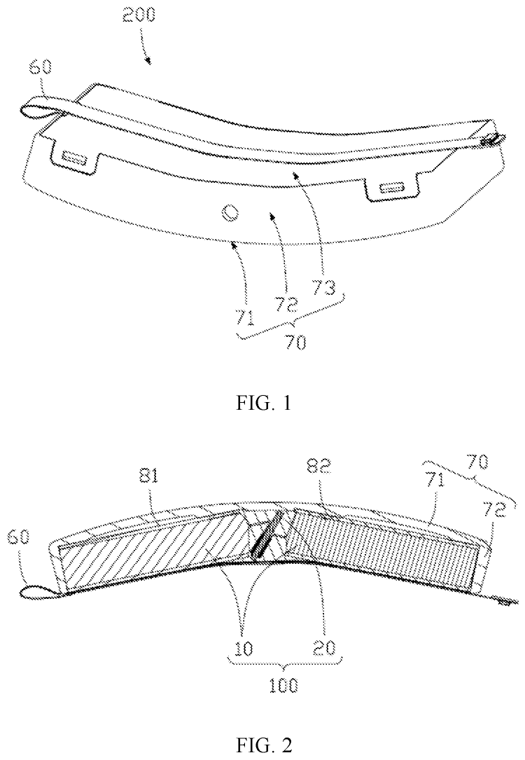

Referring to FIG. 1 and FIG. 2, in an embodiment, the battery pack 200 includes a battery module 100 and a shell 70. The battery module 100 is accommodated in the shell 70. The battery module 100 includes a cell assembly and a first circuit board 20. The cell assembly includes a plurality of battery cells 10. The battery cells 10 are connected to the first circuit board 20.

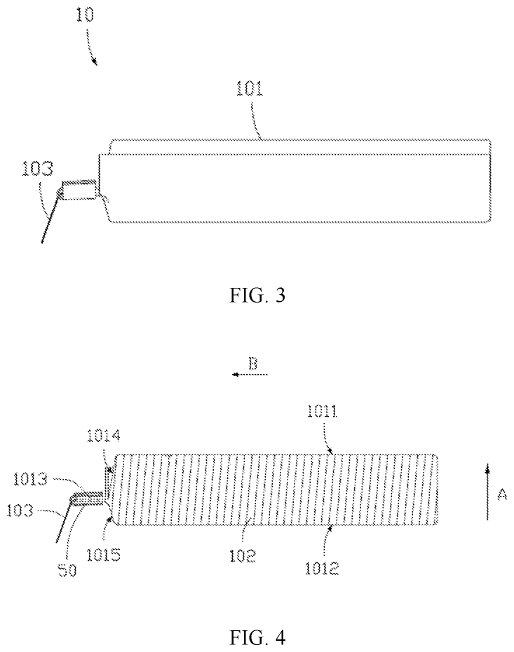

Still referring to FIG. 3 and FIG. 4, in an embodiment of this application, the plurality of battery cells 10 are pouch-type cells. Each battery cell 10 includes a housing 101 and an electrode assembly 102 accommodated in the housing 101. The electrode assembly 102 includes a tab 103. The tab 103 extends out of the housing 101. Along a thickness direction of the battery cell 10, that is, a direction indicated by the arrow A in FIG. 4, the housing 101 includes a first main plane 1011 and a second main plane 1012 that are disposed opposite to each other. Further, a seal edge 1013 is disposed at one end of the housing 101 along a length direction of the battery cell 10, that is, a direction indicated by the arrow B in FIG. 4. The tab 103 extends out of the housing 101 from the seal edge 1013. The housing 101 further includes a first surface 1014 and a second surface 1015. The first surface 1014 connects the seal edge 1013 and the first main plane 1011. The second surface 1015 connects the seal edge 1013 and the second main plane 1012. Along the thickness direction, the width of the first surface 1014 is greater than the width of the second surface 1015.

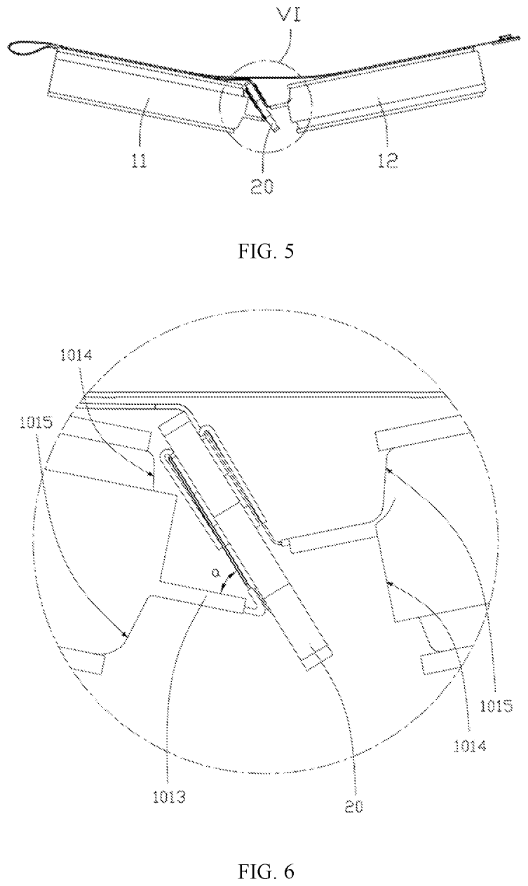

Referring to FIG. 5 and FIG. 6, in an embodiment of this application, the plurality of battery cells 10 include a first battery cell 11 and a second battery cell 12. The first battery cell 11 is inclined with respect to the second battery cell 12. The structure of the first battery cell 11 is approximately identical to the structure of the second battery cell 12. In some embodiments, the plurality of battery cells 10 may further include a third battery cell, a fourth battery cell, and the like, without being limited in this application. The first circuit board 20 is disposed between the first battery cell 11 and the second battery cell 12. The first circuit board 20 is inclined with respect to the first battery cell 11, and the first circuit board 20 is inclined with respect to the second battery cell 12. In the battery module 100, the first circuit board 20 is disposed in the space vacated by tilting between the first battery cell 11 and the second battery cell 12, thereby sufficiently utilizing the space inside the battery and effectively increasing the energy density.

One end of the first circuit board 20 tilts closer to the first surface 1014 of the first battery cell 11, and an opposite end of the first circuit board 20 tilts closer to the first surface 1014 of the second battery cell 12. Because the width of the first surface 1014 is greater than the width of the second surface 1015, the first circuit board 20 can be disposed more efficiently by use of the relatively large width of the first surface 1014 when both opposite ends of the first circuit board 20 tilt toward the first surface 1014. The first circuit board 20 is at an acute angle a to the seal edge 1013 of the first battery cell 11. The range of the acute angle a may be adjusted according to the tilt angle of the battery cell 10 and the tilt angle of the first circuit board 20. A preferred acute angle range is 30° to 60°.

The first surface 1014 of the first battery cell 11 is opposite to the second surface 1015 of the second battery cell 12. The second surface 1015 of the first battery cell 11 is opposite to the first surface 1014 of the second battery cell 12.

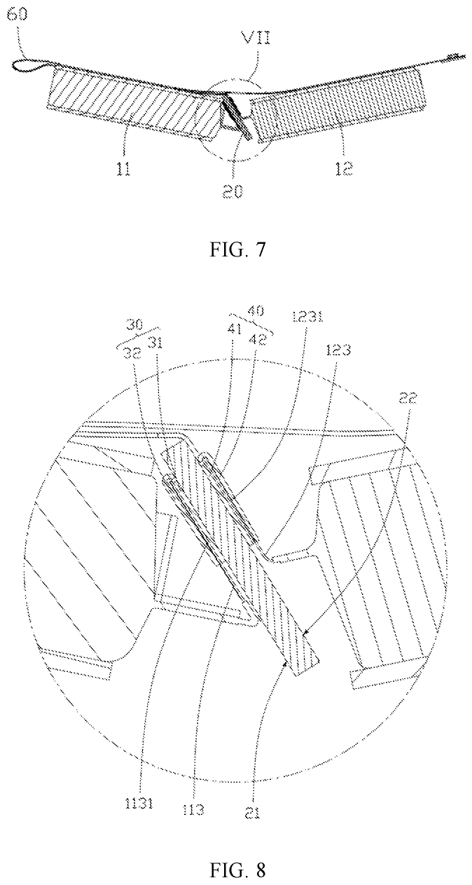

Still referring to FIG. 7 and FIG. 8, the first battery cell 11 includes a first tab 113. The second battery cell 12 includes a second tab 123. The first tab 113 is opposite to the second tab 123. The first circuit board 20 is disposed between the first tab 113 and the second tab 123. The first tab 113 tilts closer to the first surface 1014 of the first battery cell 11, and the second tab 123 tilts closer to the second surface 1015 of the second battery cell 12. The first circuit board 20 includes a first side 21 and a second side 22 that are disposed opposite to each other. The first tab 113 is disposed on the first side 21. The second tab 123 is disposed on the second side 22. The first tab 113 and the second tab 123 may be directly soldered to the first circuit board 20, for example, by SMT or DIP, or may be connected to the first circuit board 20 by other connecting strips. The first tab 113 and the second tab 123 are made of a conductive metal or alloy, such as copper, aluminum, nickel, nickel-clad copper, nickel-clad aluminum, and the like. The first tab 113 and the second tab 123 is highly bendable, and can be bent by different angles as required by the battery module 100, thereby occupying a smaller space.

Still referring to FIG. 7 and FIG. 8, in this embodiment, the battery module 100 further includes a first connecting strip 30 and a second connecting strip 40. The first connecting strip 30 is configured to connect the first tab 113 and the first circuit board 20. The second connecting strip 40 is configured to connect the second tab 123 and the first circuit board 20. The first tab 113 includes a first soldering portion 1131, and the second tab 123 includes a second soldering portion 1231. The first connecting strip 30 includes a first fixing portion 31 and a first connecting portion 32. The first fixing portion 31 is soldered to the first circuit board 20. The first connecting portion 32 is welded to the first soldering portion 1131. The first soldering portion 1131 is disposed between the first fixing portion 31 and the first connecting portion 32. The second connecting strip 40 includes a second fixing portion 41 and a second connecting portion 42. The second fixing portion 41 is soldered to the first circuit board 20. The second connecting portion 42 is welded to the second soldering portion 1231. The second soldering portion 1231 is disposed between the second fixing portion 41 and the second connecting portion 42.

To facilitate the manufacture of the battery module 100, before the battery cell 10 is connected to the first circuit board 20, the first connecting strip 30 and the second connecting strip 40 are of an L-shaped structure. The first fixing portion 31 is approximately perpendicular to the first connecting portion 32. The second fixing portion 41 is approximately perpendicular to the second connecting portion 42. The first soldering portion 1131 is welded to the first connecting portion 32, the second soldering portion 1231 is welded to the second connecting portion 42. The first fixing portion 31 is soldered to the first circuit board 20, the second fixing portion 41 is soldered to the first circuit board 20. The first battery cell 11 and the second battery cell 12 are perpendicular to the first circuit board 20. Subsequently, the first tab 113 and the second tab 123 are bent so that the first soldering portion 1131 is sandwiched between the first fixing portion 31 and the first connecting portion 32. The second soldering portion 1231 is sandwiched between the second fixing portion 41 and the second connecting portion 42. In addition, the second battery cell 12 is inclined with respect to the first battery cell 11. The first circuit board 20 is inclined with respect to the first battery cell 11, the first circuit board 20 is inclined with respect to the second battery cell 12. By disposing the first connecting strip 30 and the second connecting strip 40, the space of the first circuit board 20 can be utilized more efficiently. For example, the first fixing portion 31 and the second fixing portion 41 may be soldered onto different positions of the circuit board according to the design of the first circuit board 20. In addition, the connecting strips facilitate control of the bending angle. For example, the first fixing portion 31 and the first connecting portion 32 may be bent to form different angles as required.

In this embodiment, the first fixing portion 31 and the first connecting portion 32 clamp the first soldering portion 1131. One surface of the first soldering portion 1131 is in contact with the first connecting portion 32, and an opposite surface of the first soldering portion 1131 is in contact with the first fixing portion 31. The second fixing portion 41 and the second connecting portion 42 clamp the second soldering portion 1231. One surface of the second soldering portion 1231 is in contact with the second connecting portion 42, and an opposite surface of the second soldering portion 1231 is in contact with the second fixing portion 41. Through contact and clamping, the first connecting strip 30 can be fixed to the first soldering portion 1131 more stably, thereby preventing the first connecting strip 30 from detaching from the first soldering portion 1131 in the case of dropping or in other cases. In other examples, the opposite surface of the first soldering portion 1131 may be fixedly connected to the first fixing portion 31 in other ways such as gluing.

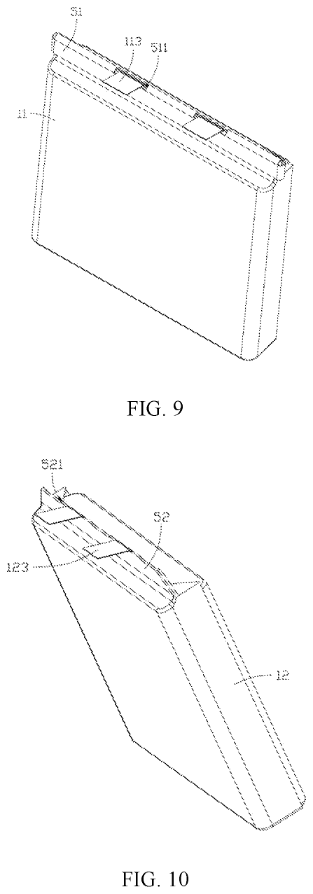

Referring to FIG. 4, FIG. 9, and FIG. 10, the battery module 100 further includes an insulation piece 50. The insulation piece 50 wraps at least a part of a seal edge 1013 of the battery cell 10. The insulation piece 50 includes a first insulation piece 51 and a second insulation piece 52. The first insulation piece 51 wraps at least a part of the seal edge 1013 of the first battery cell 11. The second insulation piece 52 wraps at least a part of the seal edge 1013 of the second battery cell 12. A first opening 511 is provided on the first insulation piece 51. The first tab 113 protrudes from the first opening 511. A second opening 521 is provided on the second insulation piece 52. The second tab 123 protrudes from the second opening 521. The insulation piece 50 can support the seal edge 1013 on the one hand to prevent deformation, and can isolate the tab 103 on the other hand to reduce the probability of short circuits.

Still referring to FIG. 1 and FIG. 2, the battery pack 200 further includes a second circuit board 60. One end of the second circuit board 60 is connected to the first circuit board 20. Another end of the second circuit board 60 protrudes out of the shell 70. In an embodiment of this application, the second circuit board 60 is a flexible circuit board. Along the length direction of the cell assembly, the second circuit board 60 protrudes from one side of the shell 70.

The battery pack 200 further includes a spacer 14. The spacer 14 is disposed on the first main plane 1011 and the second main plane 1012 of the battery cell 10 along the thickness direction of the battery cell 10. The spacer 14 is made of a material including but not limited to foam, and is configured to absorb an expansion volume of the battery cell 10.

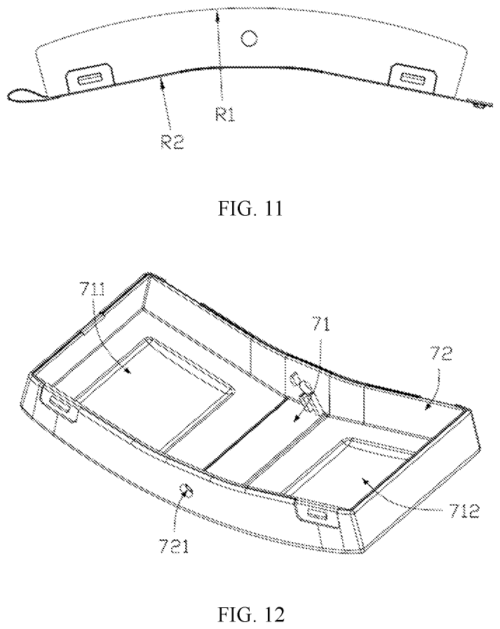

The shell includes an arc bottom plate 71, side plates 72 disposed around the arc bottom plate 71, and an arc cover plate 73. The side plates 72 and the arc bottom plate 71 are formed in one piece. Lateral edges of the arc cover plate 73 are fixedly connected to the side plates 72 by, but without being limited to, snapping, riveting, welding, gluing, or the like. To reduce damage to the shell 70, the second circuit board 60 protrudes from between the arc cover plate 73 and one of the side plates 72. Referring to FIG. 11, an arc radius R1 of the arc bottom plate 71 is 85 to 110 mm, and an arc radius R2 of the arc cover plate 73 is 80 to 100 mm. In this embodiment, the arc bottom plate 71 is a plastic part formed in one piece, and the arc cover plate 73 is a steel sheet. The steel sheet improves the resistance-to-impact of the battery pack 200 impacted by an external force. The integrally formed steel sheet avoids harm to the user during failure of the battery. In an embodiment, the battery pack 200 is applicable to headsets. The arc cover plate 73 is close to the user's head. The steel sheet is stronger than a plastic piece. When the battery fails, the arc bottom plate 71 is damaged first, thereby protecting the head.

Referring to FIG. 2 and FIG. 12, a first groove 711 and a second groove 712 are disposed in the inner sidewall of the arc bottom plate 71, and are configured to provide an expansion space for the first battery cell 11 and the second battery cell 12 respectively. The battery pack 200 further includes a first spacer 81 and a second spacer 82. The first spacer 81 is disposed between the first battery cell 11 and the first groove 711. The second spacer 82 is disposed between the second battery cell 12 and the second groove 712. The first spacer 81 covers the first groove 711, and the second spacer 82 covers the second groove 712. The first spacer 81 and the second spacer 82 are configured to support the first battery cell 11 and the second battery cell 12.

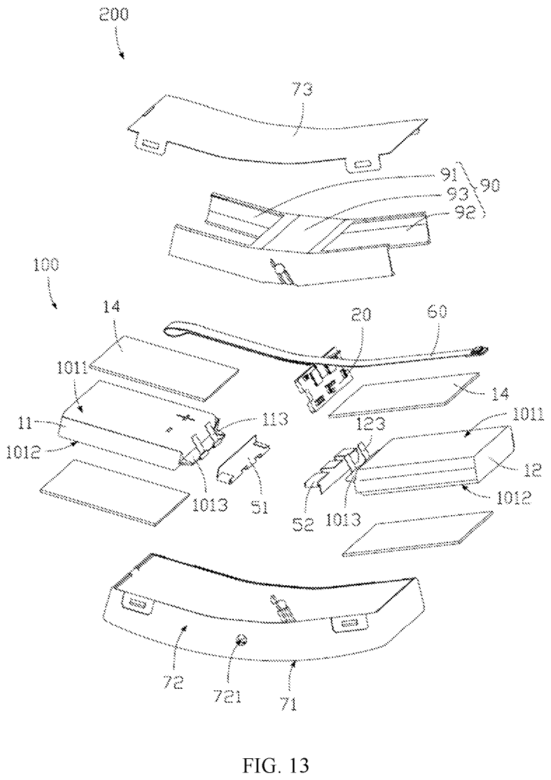

Referring to FIG. 13, in another embodiment, the structure of the battery pack 200 is approximately identical to that in the preceding embodiment except that the battery pack 200 further includes a fastener 90 configured to fix the cell assembly. The fastener 90 is accommodated in a space between the shell 70 and the cell assembly. The fastener 90 includes a first bracket 91, a second bracket 92, and a connecting portion 93. The first bracket 91 and the second bracket 92 are disposed on two opposite sides of the connecting portion 93 respectively. The first bracket 91 is inclined with respect to the connecting portion 93, and the second bracket 92 is inclined with respect to the connecting portion 93. The first battery cell 11 is held by the first bracket 91, and the second battery cell 12 is held by the second bracket 92. The first circuit board 20 is attached obliquely to the connecting portion 93. In other embodiments, the fastener 90 is resin that fills the space between the shell 70 and the cell assembly. The resin fills a clearance between the shell 70 and the cell assembly to fix the cell assembly. The resin may be plastic. An injection hole 721 is provided on the side plate 72 of the shell 70. The resin is injected to fill in the shell 70 through the injection hole 721 by low-pressure injection molding. The resin can flow from a through-hole 931 into the clearance between the first battery cell 11, the second battery cell 12, and the first circuit board 20, so as to ensure that the clearance can be filled. The battery pack 200 filled with the resin is waterproof In addition, the resin exerts a protective effect on the battery cell 10 to some extent to prevent damage to the battery cell 10 that is dropped accidentally or in other circumstances. In other embodiments, the resin is a potting glue. The potting glue is injected to fill in the shell 70 through the injection hole 721. In other embodiments, the fastener 90 may include a fixing bracket and resin concurrently to implement securer fixing.

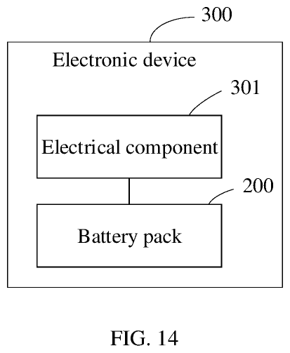

Referring to FIG. 14, an embodiment of this application further provides an electronic device 300. The electronic device 300 includes an electrical component 301 and the battery pack 200 according to any one or any combination of some embodiments described above. The electrical component 301 is electrically connected to the battery pack 200.

The foregoing some embodiments are merely intended for describing the technical solutions of this application but not intended as a limitation. Although this application is described in detail with reference to the foregoing exemplary some embodiments, a person of ordinary skill in the art understands that modifications or equivalent substitutions may be made to the technical solutions of this application without departing from the spirit and scope of the technical solutions of this application.

What is claimed is:

1. A battery module, comprising:
a cell assembly comprising a plurality of battery cells; and
a first circuit board, the plurality of battery cells are connected to the first circuit board;
wherein the plurality of battery cells comprise a first battery cell and a second battery cell, and the first battery cell is inclined with respect to the second battery cell; and
the first circuit board is disposed between the first battery cell and the second battery cell, the first circuit board is inclined with respect to the first battery cell, and the first circuit board is inclined with respect to the second battery cell.

2. The battery module according to claim 1, wherein each battery cell comprises a housing and an electrode assembly accommodated in the housing, and the electrode assembly comprises a tab;
the housing comprises a first main plane and a second main plane disposed opposite to each other along a thickness direction of the battery cell, a seal edge is disposed at one end of the housing along a length direction of the battery cell, and the tab extends out of the housing from the seal edge;
the first battery cell comprises a first tab, the second battery cell comprises a second tab, and the first tab is opposite to the second tab; and
the housing further comprises a first surface and a second surface, the first surface connects the seal edge and the first main plane, the second surface connects the seal edge and the second main plane, and a width of the first surface is greater than a width of the second surface along the thickness direction.

3. The battery module according to claim 2, wherein the first circuit board is disposed between the first tab and the second tab.

4. The battery module according to claim 2, wherein the first tab comprises a first soldering portion, and the second tab comprises a second soldering portion;
the battery module comprises a first connecting strip and a second connecting strip ;
the first connecting strip comprises a first fixing portion and a first connecting portion, the first fixing portion is soldered to the first circuit board, the first connecting portion is welded to the first soldering portion, and the first soldering portion is disposed between the first fixing portion and the first connecting portion; and
the second connecting strip comprises a second fixing portion and a second connecting portion, the second fixing portion is soldered to the first circuit board, the second connecting portion is welded to the second soldering portion, and the second soldering portion is disposed between the second fixing portion and the second connecting portion.

5. The battery module according to claim 4, wherein the first fixing portion and the first connecting portion clamp the first soldering portion, one surface of the first soldering portion is in contact with the first connecting portion, and an opposite surface of the first soldering portion is in contact with the first fixing portion; and
the second fixing portion and the second connecting portion clamp the second soldering portion, one surface of the second soldering portion is in contact with the second connecting portion, and an opposite surface of the second soldering portion is in contact with the second fixing portion.

6. The battery module according to claim 4, wherein the first soldering portion is disposed between the first surface of the first battery cell and the first circuit board, and the second soldering portion is disposed between the second surface of the second battery cell and the first circuit board.

7. The battery module according to claim 4, wherein the first circuit board comprises a first side and a second side disposed opposite to each other, the first tab is disposed on the first side, and the second tab is disposed on the second side.

8. The battery module according to claim 2, wherein the first circuit board is at an acute angle to the seal edge of the first battery cell, and the acute angle ranges from 30° to 60°.

9. The battery module according to claim 2, wherein the battery module further comprises a first insulation piece and a second insulation piece, the first insulation piece wraps at least a part of the seal edge of the first battery cell, and the second insulation piece wraps at least a part of the seal edge of the second battery cell.

10. The battery module according to claim 9, wherein a first opening is provided on the first insulation piece, the first tab protrudes from the first opening, a second opening is provided on the second insulation piece, and the second tab protrudes from the second opening.

11. A battery pack, wherein the battery pack comprises a shell and the battery module according to claim 1, and the battery module is accommodated in the shell.

12. The battery pack according to claim 11, wherein the battery pack further comprises a second circuit board, one end of the second circuit board is connected to the first circuit board of the battery module, and another end of the second circuit board protrudes out of the shell.

13. The battery pack according to claim 12, wherein the shell comprises an arc bottom plate, a first groove and a second groove are provided on an inner sidewall of the arc bottom plate; and the battery pack further comprises a first spacer and a second spacer, the first spacer is disposed between the first battery cell of the battery module and the first groove, and the second spacer is disposed between the second battery cell of the battery module and the second groove.

14. The battery pack according to claim 13, wherein the first spacer covers the first groove, and the second spacer covers the second groove.

15. The battery pack according to claim 13, wherein an arc radius of the arc bottom plate is 85 to 110 mm.

16. The battery pack according to claim 13, wherein the shell further comprises a side plate and an arc cover plate the side plate is disposed around the arc bottom plate, the arc cover plate is fixedly connected to the side plate, and an arc radius of the arc cover plate is 80 to 100 mm.

17. The battery pack according to claim 11, wherein the battery pack further comprises a fastener, the fastener comprises a first bracket, a second bracket, and a connecting portion; the first bracket and the second bracket are disposed on two opposite sides of the connecting portion respectively; and the first battery cell of the battery module is held by the first bracket, the second battery cell is held by the second bracket, and the first circuit board is attached to the connecting portion.

18. The battery pack according to claim 17, wherein the fastener is resin, and the fastener is configured to fill a clearance between the shell and the cell assembly of the battery module.

19. The battery pack according to claim 18, wherein an injection hole is provided on the shell, and the resin fills the shell by low-pressure injection molding.

20. An electronic device, wherein the electronic device comprises an electrical component and the battery pack according claim 11, and the electrical component is electrically connected to the battery pack.
